(19) United States
(12) Patent Application Publication
(10) Pub. No.: US 2026/0220233 A1
(43) Pub. Date: Jul. 30, 2026

(54) METHODS AND SYSTEMS FOR ENFORCING RESTRICTIONS ON SOFTWARE AGENT

(71) Applicant: Shopify Inc., Ottawa (CA)

(72) Inventors: Brennan LETKEMAN, Calgary (CA); Daniel BEAUCHAMP, Ottawa (CA)

(21) Appl. No.: 19/036,643

(22) Filed: Jan. 24, 2025

(51) Int. Cl. G06F 21/12; G06F 21/62; G06F 40/30

(52) U.S. Cl. CPC G06F 21/121; G06F 21/6281; G06F 40/30

(57) ABSTRACT

Methods and systems for enforcing restrictions against actions by a software agent are described. A request is received from a software agent to cause execution of an attempted action. A policy header is extracted from the request. Data representing an instructed task assigned to the software agent is extracted from the policy header. The attempted action is selectively caused to be executed based on whether the attempted action is suitable to a semantic meaning of the instructed task.

### FIELD

The present disclosure relates to managing software agents, and in particular methods and systems related to restricting execution of actions caused by software agents on a platform or server.

### BACKGROUND

Software agents include artificial intelligence (AI) agents (e.g., chatbot agents, which may be powered by large language models (LLMs)), which may be capable of autonomously interacting with web-based services to perform a variety of tasks such as making transactions, accessing guarded resources, or setting up appointments on behalf of a human user. It is important to consider how to implement and enforce restrictions on what actions such software agents can cause to be performed. For example, a user may not want a software agent to perform certain actions without explicit consent, such as actions that involve executing important transactions (e.g., financial transactions, certain types of data creation or deletion, etc.) or accessing sensitive information (e.g., health information, financial information, etc.).

### SUMMARY

A software agent may refer to various types of software that performs actions on behalf of a human user or client device (without necessarily involving a human user). Advanced software agents include AI agents, which may be capable of carrying out complex tasks that may require multiple steps or actions to perform. An advanced software agent may be based on an LLM, and may be referred to as an LLM-based agent or an LLM agent. An LLM agent may be instructed to perform a task in the context of an ongoing conversation (e.g., a chat session or a messaging session), for example a user may be interacting with an LLM agent (e.g., a chatbot) and may request a task to be carried out in the context of that conversation. In some examples, the ongoing conversation may be a messaging session involving system messages between the LLM agent and another computer system (without involving any human user).

For more complex tasks, it may be difficult to directly relate the actions performed by a software agent directly to the instructed task. For example, an LLM agent may use an LLM to break down a complex task into subtasks, generate data representing an action to be performed (e.g., data for making a function call) for each subtask, and relate the outcomes resulting from completion of the subtasks in order to complete the task. This means that different software agents may carry out the same instructed task in different ways (e.g., by making different function calls, by performing subtasks in different order, by accessing different data, etc.). However, software agents, including LLM agents, may fail to carry out the intent or meaning of the instructed task (e.g., fail to take into account the context of the instructed task, or fail to stay within restrictions specific to the instructed task) and/or may generate data representing erroneous actions (e.g., hallucinations).

Thus, it may be important to check and/or restrict a software agent's actions. However, due to the complexity discussed above checking a software agent's actions against the instructed task can be difficult. For example, simply checking whether a defined set of steps is being performed by a software agent in a defined order may not be a suitable way to ensure the software agent is correctly carrying out an instructed task because different software agents may carry out the same instructed task correctly but in different ways. As well, there may be implicit restrictions to the instructed task that are found in the context of the instructed task (e.g., in the context of a conversation that the user or client device conducted with the software agent prior to instructing the task), which may not be easily checked.

As such, there is a challenge in that it can be difficult to check whether a software agent is causing execution of an action (e.g., making a function call or accessing certain data) outside the meaning and/or restrictions of its instructed task until the software agent has completed all subtasks and reports back on completion of the task. This can be problematic because if the software agent's actions were contrary to the intent of the instructed task or outside the restrictions specific to the instructed task, it can be a waste of computing resources both in the resources consumed to perform the erroneous actions as well as in the resources consumed to undo the erroneous actions. Additionally, the complexity of some tasks and systems may result in the erroneous actions being undetected until much later, at which time undoing the erroneous actions may be extremely difficult or impossible.

In some examples, different users or client devices may wish to apply different restrictions against a software agent. As such, a broad platform- or server-wide set of restrictions against certain software agent actions may not be appropriate or suitable to address the challenges discussed above.

Conventional approaches to restricting a software agent's actions typically focus on completely blocking certain software agents (e.g., unwanted web crawlers, malicious agents or spam bots) from performing any actions on a software platform (or server), or blocking software agents from accessing certain types of data (e.g., private or sensitive data such as financial data). Such approaches fail to provide flexibility, fail to account for individual client's preferences, and fail to check a software agent's actions against its instructed task. For example, a software agent may perform actions that are all within conventional platform-wide rules, but may be outside the specific parameters and/or intent of the instructed task.

In various examples, the present disclosure provides a technical solution that enables a platform to authenticate a software agent attempting to cause execution of an action on the platform (e.g., to authenticate that the software agent is from a trusted source). Examples disclosed herein enable information about task-specific restrictions to be included in a policy header carried in the request of the software agent. This provides greater flexibility than having platform-wide restrictions. Additionally, the policy header may be encrypted in a way that enables the software agent to be authenticated as originating from a trusted source.

Examples of the present disclosure enable the platform to enforce restrictions, and ensure that an action attempted by the software agent is in accordance with the intent (or semantic meaning) of the instructed task. This avoids the problem where a software agent unintentionally attempts to cause execution of an action contrary to the intent of the instructed task. Notably, while conventional platform-wide restrictions may be used to address a problem of intentionally malicious actions by a malicious software agent, the present disclosure further addresses a problem of unintentional error by a non-malicious software agent.

Other advantages provided by the examples of the present disclosure will be apparent to one skilled in the art in the context of the detailed description.

In an example aspect, the present disclosure describes a computer-implemented method including: receiving a request from a software agent to cause execution of an attempted action; extracting, from the request, a policy header; extracting, from the policy header, data representing an instructed task assigned to the software agent; and selectively causing execution of the attempted action based on whether the attempted action is suitable to a semantic meaning of the instructed task.

In any of the preceding examples of the method, the policy header extracted from the request may be encrypted, and the method may further include: prior to extracting the data representing the instructed task, decrypting the policy header to verify that a source of the software agent is a trusted source.

In any of the preceding examples of the method, the policy header may be encrypted and signed by a private key owned by the trusted source.

In any of the preceding examples of the method, the method may further include: determining whether the attempted action is suitable to the semantic meaning of the instructed task by: providing a string representation of the attempted action and a string representation of the instructed task as inputs to a language model; obtaining, from the language model, a predicted suitability between the attempted action and the instructed action; and determining whether the attempted action is suitable to the semantic meaning of the instructed task based on the predicted suitability.

In any of the preceding examples of the method, the method may further include: identifying, from the policy header, at least one restriction to be applied to the instructed task or the attempted action, wherein the at least one restriction is included as an input to the language model.

In any of the preceding examples of the method, the method may further include: extracting, from the policy header, an identifier of a client associated with the software agent or associated with the instructed task; and identifying, from a client profile of the client, at least one client-defined restriction that limits actions by the software agent; wherein selectively causing execution of the attempted action may be further based on whether the attempted action is permissible within the at least one client-defined restriction.

In any of the preceding examples of the method, selectively causing execution of the attempted action may include: after determining that the attempted action is suitable to the semantic meaning of the instructed task and before causing execution of the attempted action, generating a notification to notify a client, identified in the policy header, about the attempted action.

In any of the preceding examples of the method, the notification may include a request to approve the attempted action, wherein the method may further include: receiving an approval in response to the notification; wherein selectively causing execution of the attempted action may be further based on receiving the approval.

In any of the preceding examples of the method, the method may further include: receiving a further request from the software agent to cause execution of a further attempted action; and selectively blocking execution of the attempted action based on the attempted action being unsuitable to the semantic meaning of the instructed task.

In any of the preceding examples of the method, the method may further include: storing, in an agent action log, a record of the executed attempted action together with the policy header.

In another example aspect, the present disclosure describes a computer system including at least one processor; and a computer readable medium storing instructions that, when executed by the at least one processor, cause the computer system to: receive a request from a software agent to cause execution of an attempted action; extract, from the request, a policy header; extract, from the policy header, data representing an instructed task assigned to the software agent; and one of: cause execution of the attempted action when the attempted action is suitable to a semantic meaning of the instructed task; or block execution of the attempted action when the attempted action is unsuitable to the semantic meaning of the instructed task.

In any of the preceding examples of the computer system, the policy header extracted from the request may be encrypted, and the instructions may further cause the computer system to: prior to extracting the data representing the instructed task, decrypt the policy header to verify that a source of the software agent is a trusted source.

In any of the preceding examples of the computer system, the policy header may be encrypted and signed by a private key owned by the trusted source.

In any of the preceding examples of the computer system, the instructions may further cause the computer system to: determine whether the attempted action is suitable or unsuitable to the semantic meaning of the instructed task by: providing a string representation of the attempted action and a string representation of the instructed task as inputs to a language model; obtaining, from the language model, a predicted suitability between the attempted action and the instructed action; and determining that the attempted action is suitable or unsuitable to the semantic meaning of the instructed task based on the predicted suitability.

In any of the preceding examples of the computer system, the instructions may further cause the computer system to: identify, from the policy header, at least one restriction to be applied to the instructed task or the attempted action, wherein the at least one restriction is included as an input to the language model.

In any of the preceding examples of the computer system, the instructions may further cause the computer system to: extract, from the policy header, an identifier of a client associated with the software agent or associated with the instructed task; and identify, from a client profile of the client, at least one client-defined restriction that limits actions by the software agent; wherein execution of the attempted action may be caused when the attempted action is suitable to a semantic meaning of the instructed task and when the attempted action is permissible within the at least one client-defined restriction.

In any of the preceding examples of the computer system, the instructions may further cause the computer system to cause execution of the attempted action by: when the attempted action is suitable to the semantic meaning of the instructed task and before causing execution of the attempted action, generating a notification to notify a client, identified in the policy header, about the attempted action.

In any of the preceding examples of the computer system, the notification may include a request to approve the attempted action, wherein the instructions may further cause the computer system to: receive an approval in response to the notification; wherein execution of the attempted action may be caused after receiving the approval.

In any of the preceding examples of the computer system, the instructions may further cause the computer system to: store, in an agent action log, a record of the executed attempted action together with the policy header.

In another example aspect, the present disclosure describes a non-transitory computer-readable medium storing instructions that, when executed by at least one processor of a computer system, cause the computer system to: receive a request from a software agent to cause execution of an attempted action; extract, from the request, a policy header; extract, from the policy header, data representing an instructed task assigned to the software agent; and one of: cause execution of the attempted action when the attempted action is suitable to a semantic meaning of the instructed task; or block execution of the attempted action when the attempted action is unsuitable to the semantic meaning of the instructed task.

In some examples, the computer-readable medium may store instructions that, when executed by the processor of the computing system, cause the computing system to perform any of the example aspect of the methods described above.

In another example aspect, the present disclosure provides a computer program including processor-executable instructions that, when executed by a processor of a computing system, cause the computing system to perform any of the example aspect of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of an example enforcement module, which may be used to implement examples of the present disclosure; and

FIG. 4 is a flowchart of an example method for enforcing restrictions on software agents, in accordance with examples of the present disclosure.

Similar reference numerals may have been used in different figures to denote similar components.

### DETAILED DESCRIPTION

In various examples, the present disclosure describes methods and systems for enforcing restrictions on actions attempted by a software agent, including an advanced software agent such as an LLM agent or AI agent. The present disclosure describes an enforcement module at a platform (e.g., a web-based platform or a server) that performs operations to ensure that a software agent is causing actions in accordance with the intent of the instructed task, and to enforce restrictions (including client-defined restrictions and/or task-specific restrictions) against the software agent. When a software agent is dispatched to perform an action on a target platform (e.g., web-based platform or server), the request carried by the software agent includes an encrypted policy header that includes data representing an instructed task the software agent is to carry out and optionally parameter(s) for that task. When the software agent attempts to cause execution of an action on the target platform, the enforcement module inspects the policy header to check whether the attempted action is in accordance with the semantic meaning of the instructed task and within any optional parameter(s) for that task.

While examples of the present disclosure are discussed in the context of an LLM agent, it should be understood that the present disclosure may also be relevant to enforcement of restrictions on other types of software agents, including software agents powered by other machine learning models as well as non-machine learning software agents. As such, the present disclosure is not necessarily limited to implementation with LLM agents.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

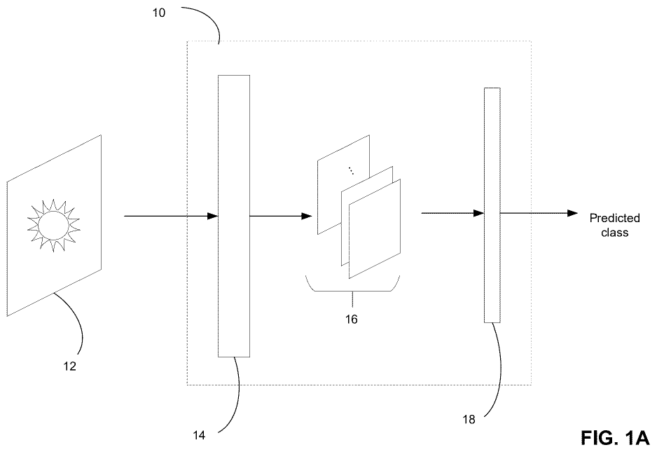

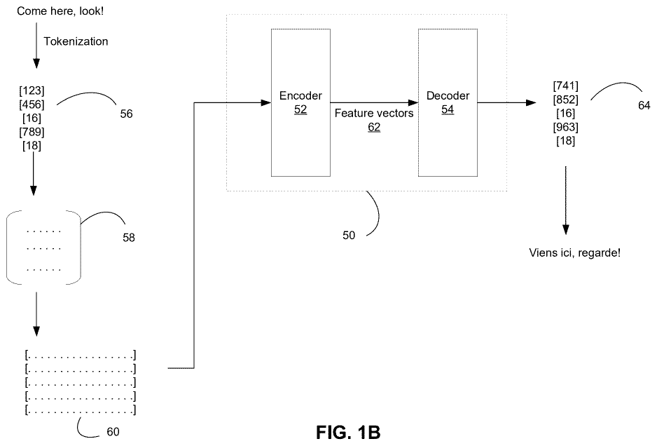

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

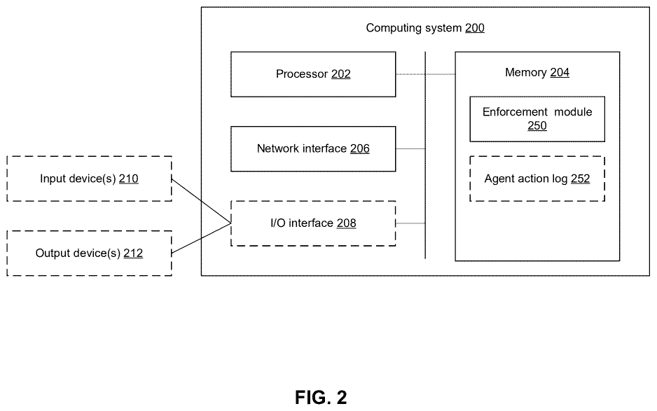

FIG. 2 illustrates an example computing system 200, which may be used to implement examples of the present disclosure. For example, the computing system 200 may be used to generate a prompt to an LLM to cause the LLM to generate output. Additionally or alternatively, one or more instances of the example computing system 200 may be employed to execute the LLM. For example, a plurality of instances of the example computing system 200 may cooperate to provide output using an LLM in manners as discussed above.

The example computing system 200 includes at least one processing unit and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to cause the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). The network interface 206 may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing an enforcement module 250 and optionally may also store data such as an agent action log 252.

The computing system 200 may be used to implement a platform and a software agent may attempt to cause an action to be performed on the platform (e.g., carry out a transaction on the platform, access data maintained by the platform, create a data object on the platform, etc.). In general, the platform may refer to one or more servers, a mobile computing platform, a cloud computing platform, a stationary computing platform, etc. The platform may, for example, provide cloud-based services, such as software as a service (SaaS).

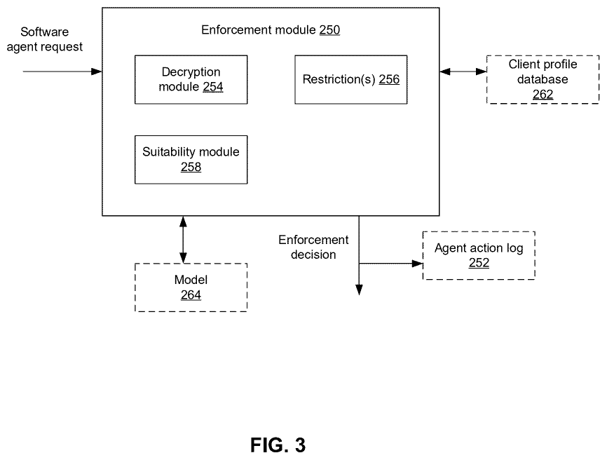

FIG. 3 is a block diagram illustrating details of an example enforcement module 250. The enforcement module 250 as disclosed herein may be used to enforce restrictions against actions attempted by a software agent on a platform.

Although the enforcement module 250 is illustrated with certain modules, this is only exemplary and is not intended to be limiting. There may be greater or fewer numbers of modules in the enforcement module 250. Operations described as being performed by a particular module may be performed by a different module, or may be an overall function of the enforcement module 250, for example. Additionally, certain blocks that are illustrated as being external to the enforcement module 250 may be internal to the enforcement module 250, and vice versa.

In this example, the enforcement module 250 includes a decryption module 254, stored restriction(s) 256 and a suitability module 258. Optionally, the enforcement module 250 may have access to a client profile database 262, a trained model 264 and the agent action log 252. As illustrated in FIG. 3, the enforcement module 250 may process a software agent request that attempts to cause execution of an action (which may be simply referred to an attempted action), and may output an enforcement decision (e.g., permitting execution of the action or blocking execution of the action).

A software agent may attempt an action by causing an execution of the action by another component of the platform rather than the software agent performing the action itself. For example, a software agent may attempt to cause execution of an action by making a request that includes a function call to execute a function of the platform. In another example, a software agent may attempt to cause execution of an action by making a request to another agent native to the platform to perform the action (and the agent native to the platform may in turn make the function call). In general, the examples disclosed herein may be used to enforce restrictions to prevent a software agent from making any request or causing execution of any action that would be contrary to the intention of the software agent's instructed task and/or contrary to any other restrictions relevant to the software agent.

A software agent that is not native to the platform may be from a source application that is external to the platform. The software agent may be an LLM agent that has been asked to carry out an instructed task on the platform. For example, an LLM agent may be instructed to carry out a task as part of a conversation or messaging session with a client device, or as a step within a larger workflow. In general, the software agent may make a request to the platform to execute an action, and the software agent request may be processed by the enforcement module 250 as disclosed herein.

The software agent request includes a policy header in addition to the payload that contains data related to an attempted action (e.g., the payload may contain input parameters and syntax for making a function call, the payload may contain the function call itself, or the payload may be a request to an agent of the platform to carry out a task, etc.). The policy header is generated by the source application. The policy header includes data (e.g., a data string) representing an instructed task that has been assigned to the software agent to carry out on the platform. The instructed task may be represented by a text string that describes the instructed task using natural human language (e.g., “I want to close my bank account”). This may be the case where the software agent is a chatbot agent that is carrying out an action that was instructed by a human user in the context of a conversation with a chatbot. In some examples, the instructed task may be in the form of a system message that describes the instructed task using system syntax (e.g., in the case where the software agent is performing a task on behalf of another computing device). In some examples, the software agent's instructed task may be to perform a task repeatedly (e.g., checking the status of an account on a daily basis) or to perform a task when certain conditions are met (e.g., cancelling a restaurant reservation when the weather forecast is rain). As such, the semantic meaning of the instructed task may include parameters and/or restrictions that are implicit to the task.

The policy header can contain other information such as a context of the instructed task (e.g., a summary of the conversation history up to the instructed task, in the case of a chatbot agent), explicit parameter(s) that restrict the instructed task, parameter(s) that restrict the actions/capabilities of the software agent, identifier of the software agent (e.g., bot token), identifier of the client device or user the software agent is acting on behalf of, timestamp and/or expiry time, etc. In examples where an instructed task was instructed as part of a conversation, providing contextual information such as a summary of the conversation in the policy header may enable more accurate understanding of the semantic meaning of the instructed task. For example, parameters and/or restrictions that apply to the instructed task may be stated or implied in messages in the conversation history prior to the message containing the instructed task.

The policy header in the software agent request may be encrypted and signed by the source application. This may help to authenticate the software agent as being from a trusted source application, for example.

The enforcement module 250 uses the decryption module 254 to decrypt the policy header of the software agent request and to check the signature on the policy header to ensure the software agent is from a trusted source. For example, the enforcement module 250 may maintain a list of trusted sources (not shown in FIG. 3) that can be compared with the signature of the decrypted policy header. If the source of the software agent is not a trusted source or cannot be verified, the enforcement module 250 may output an enforcement decision that blocks the software agent request. Optionally, the enforcement module 250 may log the software agent request and enforcement decision in the agent action log 252, and may include a reason for the enforcement decision in the agent action log 252 (e.g., “agent source cannot be verified”).

If the source of the software agent has been verified to be a trusted source (e.g., the decryption module 254 confirms that the signature of the decrypted policy header matches an entry in the list of trusted sources), the enforcement module 250 extracts the data representing the instructed task from the policy header. The enforcement module 250 may also extract any associated optional parameter(s) from the policy header including any parameter(s) that define restriction(s) on the instructed task (e.g., time restriction, monetary restriction, category restrictions, etc.), as well as any other information contained in the policy header (e.g., contextual information such as a conversation summary, identifier of the software agent (e.g., bot token), identifier of the client device or user (generally referred to as client) the software agent is acting on behalf of, timestamp and/or expiry time). Additionally, the enforcement module 250 may determine whether any of the stored restriction(s) 256 (which may be restrictions defined by the platform) apply. For example, the enforcement module 250 may store restriction(s) 256 that apply to all software agents (e.g., prevent all agents from accessing financial data on the platform), may apply only to certain software agents (e.g., prevent software agents from a defined source application from accessing financial data on the platform), may apply to software agents acting on behalf of certain categories of clients (e.g., a software agent acting on behalf of a client registered on the platform may be less restricted than another software agent acting on behalf of a non-registered client), etc.

The enforcement module 250 may optionally access a client profile database 262 of the platform to determine whether any client-specific and/or client-defined restriction(s) should be applied. The enforcement module 250 may extract, from the decrypted policy header, an identifier of the client that the software agent is acting on behalf of and may identify, from the client profile database 262, a client profile corresponding to the extracted client identifier. The client profile may contain client-specific and/or client-defined restriction(s) that should be applied to the software agent.

The enforcement module 250 may use a rules-based approach to check whether the attempted action indicated in the software agent request is permitted within the restriction(s) that have been identified by the enforcement module 250 as described above. The identified restriction(s) (e.g., identified from the policy header, identified form a client profile and/or identified from restrictions defined by the platform) may additionally or alternatively be provided to the suitability module 258.

The enforcement module 250 uses the suitability module 258 to check whether the attempted action is in accordance with the instructed task indicated in the policy header. The suitability module 258 may be provided with the data in the software agent request that is related to the attempted action (e.g., the data in the software agent request may include a function call, the data may include input parameters and syntax for making a function call, the data may include a request to an agent of the platform to carry out a task, etc.), as well as the instructed task that was extracted from the policy header of the software agent request. If the enforcement module 250 has provided identified restriction(s) to the suitability module 258, the suitability module 258 may also check whether the attempted action is in accordance with the identified restriction(s). It should be noted that the suitability module 258 checks whether the attempted action is in accordance with the intent and/or semantic meaning of the instructed task, to determine whether the attempted action is suitable or in accordance with the instructed task, and may not be limited to a strict rules-based approach.

In the example shown in FIG. 3, the suitability module 258 may generate an input (e.g., including a string representation of the attempted action and a string representation of the instructed task, for example as part of a prompt) to the trained model 264, which the model 264 processes to generate an output indicating if the attempted action in the software agent request (e.g., a function call with certain input parameters) is suitable to the semantic meaning of the instructed task. If identified restriction(s) have been provided to the suitability module 258, the identified restriction(s) may also be provided as part of the input to the model 264. The model 264 may be an LLM or any suitable trained language model (e.g., LLaMA, Falcon 40B, GPT-3, GPT-4, BART, etc.) and need not be limited to a large language model. The input to the model 264 may be provided in the form of a prompt or API request that instructs the model 264 to determine if the attempted action is suitable for the instructed task. If the suitability module 258 has been provided with identified restriction(s), the input to the model 264 may additionally instruct the model 264 to determine if the attempted action complies with the identified restriction(s). In some examples, if the policy header includes contextual information such as a conversation history or conversation summary leading up to the instructed task (e.g., in examples where the instructed task was instructed in a conversation session), the contextual information may be extracted from the policy header and the suitability module 258 may include the contextual information in the input to the model 264.

For example, the suitability module 258 may use the following example prompt template for generating a prompt to the model 264:
You are in charge of checking if a software agent is making a correct and proper action for an instructed task. You are to make a decision whether or not the action is suitable for the instructed task. You must ensure that the software agent follows all restrictions and does not perform any action outside of what is proper for the instructed task. Restrictions are cumulative, and the strictest restriction should apply.
The following restrictions are in place across the entire platform:
<platform-wide restrictions>
. . .
The following restrictions are specific to this client:
<client-specific restrictions>
. . .
The following restrictions are specific to this software agent:
<agent-specific restrictions>
. . .
The following is the instructed task that the software agent has been asked to perform:
<instructed task extracted from policy header>
. . .
This is what the software agent is attempting:
<attempted action taken from software agent request>
. . .
Suitability?

In some examples, the model 264 may have been pre-trained or fine-tuned to specifically enforce restrictions against software agents, so that the prompt provided to the model 264 may be more concise than the example prompt template provided above (e.g., the model 264 may have been pre-trained to automatically check compliance with the platform-wide restrictions).

In some examples, the model 264 may be hosted by a remote system external to the computing system 200 that implements the enforcement module 250. The enforcement module 250 may communicate with the model 264 by sending prompts via API calls, for example, and may receive messages generated by the model 264 in response. In some examples, the model 264 may be part of the enforcement module 250 and/or may be part of the suitability module 258.

The model 264 processes the input and generates an output to the suitability module 258. The output may be a predicted suitability that is in the form of a binary prediction (e.g., suitable or unsuitable attempted action, as shown in the example prompt template above), or may be a more detailed output that explains why an attempted action is considered to be suitable or unsuitable (e.g., “the action is unsuitable because it violates client-specific restriction A”). In some examples, the model 264 may be instructed to provide a predicted suitability that is expressed as a confidence level (e.g., a percentage suitability), and the suitability module 258 may use the confidence level of the predicted suitability to generate the enforcement decision.

The suitability module 258 may determine whether the enforcement decision is to permit or block the attempted action by the software agent, based on the predicted suitability from the model 264. For example, if the predicted suitability is a binary determination whether the attempted action is suitable or unsuitable, the enforcement decision from the suitability module 258 may be to block the attempted action when the attempted action is predicted to be unsuitable, and may be to permit the attempted action when the attempted action is predicted to be suitable. If the predicted suitability is a suitability confidence level, the suitability module 258 may apply a predefined threshold to the confidence level of the predicted suitability in order to generate the enforcement decision (e.g., enforcement decision may be to permit the action if the action is predicted to be suitable with a suitability confidence level of over 80%, and the enforcement decision may be to block the action otherwise). The enforcement decision may then be outputted by the enforcement module 250. In some examples, if the predicted suitability is a confidence level, the suitability module 258 may apply a dynamic threshold to the confidence level of the predicted suitability in order to generate the enforcement decision. A dynamic confidence threshold may be a threshold that is dependent on the source of the software agent (e.g., a lower confidence threshold may be applied for a more trusted source, and a higher confidence threshold may be applied for a less trusted source); may be a threshold that is dependent on the software agent's history with the platform (e.g., a lower confidence threshold may be applied for a software agent that has previously been permitted to cause execution of actions on the platform, and a higher confidence threshold may be applied for a software agent that has no history of permitted actions on the platform); etc

Optionally, if the predicted suitability is a confidence level, the suitability module 258 may apply an escalation policy if the predicted suitability confidence level is within a defined margin of a confidence threshold. For example, if the suitability module 258 applies a threshold of 80% where a predicted suitability over 80% is required for the suitability module 258 to determine that the enforcement decision is to permit the attempted action by the software agent, the suitability module 258 may apply an escalation policy if the predicted suitability confidence level is in the range of 75%-80%, or in the range of 75%-85%. The escalation policy may be, for example, to request a more complex model (e.g., a trained LLM model with more parameters than the model 264) or a panel of different models (e.g., multiple different LLM models, which may include the model 264) to generate a second predicted suitability confidence level. The second predicted suitability confidence level may then be used by the suitability module 258 to generate the enforcement decision. Optionally, if the predicted suitability confidence level is within a defined margin of a confidence threshold, the suitability module 258 may escalate to a human (e.g., a human user identified in the policy header) to verify whether the attempted action should be permitted. Verification by a human may be optionally required only for certain highly sensitive actions, such as transactions over $1000, access to medical data, etc. Verification by a human may be optionally required only when trust in the software agent may be lower, such as if the software agent has no history of permitted actions on the platform, or if the software agent is from an unfamiliar source. Optionally, in addition to verification by a human user identified in the policy header, a notification may be generated to notify a human administrator of the platform.

If the enforcement decision indicates that the attempted action should be blocked, the platform denies the attempted action by the software agent. The platform may cause the software agent to return to the source application with a message that the software agent was blocked. If a detailed explanation was provided by the model 264 for blocking the attempted action (e.g., an identification of a contravened restriction was included in the predicted suitability), the explanation may be included in the message to the source application. If the enforcement decision indicates that the attempted action is permitted, the platform permits the software agent to cause execution of the action (e.g., the software agent is permitted to make the function call contained in the payload of the software agent request). In some examples, a notification may be generated to notify a client identified in the software agent request of the action that is permitted to be executed. In some examples, the action may be executed after receiving client approval of the notification, as discussed further below.

It should be understood that, although a suitability check using a language model (e.g., the model 264 may be an LLM) is described above, the present disclosure is not limited to using an LLM to generate a predicted suitability. For example, a rules-based approach to determining suitability of an attempted task may be suitable or sufficient in some situations. In some examples, the instructed task may include binary fields indicating certain restrictions should or should not apply, and these restrictions may be checked against the attempted action in a rules-based approach.

Optionally, the attempted action, the policy header (which may be decrypted) and the enforcement decision may be logged together as a record in the agent action log 252. In some examples, the agent action log 252 may only record permitted actions together with the corresponding policy header, with the implicit understanding that all actions in the agent action log 252 were given permission to be executed by the enforcement module 250. In some examples, the record in the agent action log 252 may log data extracted from the policy header (e.g., data representing the instructed task, contextual information, an identifier of the software agent (e.g., bot token), an identifier of the client that the software agent is acting on behalf of, an identifier of the source application (e.g., as determined by the decryption module 254 based on the signature of the decrypted policy header), a timestamp, etc.) rather than the policy header itself.

The agent action log 252 may thus be used as an audit trail to identify and trace the source of any actions executed on the platform due to a software agent from an outside source. The agent action log 252 may also be inspected to verify and/or validate whether the enforcement module 250 is accurately enforcing all relevant restrictions. For example, each permitted action and associated the instructed task (and optionally any indicated restriction(s)) logged in the agent action log 252 can be checked by a human or another trained model (e.g., another model other than the model 264 used by the suitability module 258) to verify that the permitted action is a suitable action within the semantic meaning of the instructed task represented in the policy header. In some examples, records stored in the agent action log 252 may be used to train another model to predict suitability for future software agent requests.

As previously mentioned, the enforcement module 250 may generate a notification to be provided to the client identified in the policy header, to notify the client of the action that the software agent is attempting to cause to be executed on the platform. The platform may require approval or authorization from the client, in response to the notification, before the action can be executed. Optionally, the notification may request that the client authenticate themselves (e.g., using a one-time password, or providing a system token) in order to approve or authorize the action. In some examples, a notification about the attempted action may be generated to the client only if the attempted action meets certain sensitivity criteria. For example, a sensitivity criterion may be defined by the platform (e.g., stored on the enforcement module 250 as part of the restriction(s) 256) and/or may be defined in the parameter(s) included in the policy header carried in the software agent request. For example, a sensitivity criterion may indicate that the client should be notified if the attempted action involves monetary amounts exceeding a certain threshold (e.g., transfer of cash exceeding $500), involves accessing certain sensitive information (e.g., request to access medical information, or request to access credit information, request to access data belonging to a minor), etc. In some examples, the enforcement module 250 may query a client profile stored in the client profile database 262 to determine if any client-defined restrictions require the client to be notified (or not notified) of certain attempted actions by a software agent. Optionally, an administrator of the platform may be notified of the action that the software agent is attempting to cause to be executed on the platform, and the administrator may be provided an option to approve or block the action.

In some examples, the operations of the enforcement module 250 as described above may be used to enforce restrictions only for certain types of attempted actions by software agents. Low-sensitivity actions (e.g., browsing public websites, reading public database, etc.) may be generally permitted with no restrictions and the enforcement module 250 may not be used to inspect the policy header of the software agent request. The enforcement module 250 may perform operations as described above only when the software agent attempts to cause execution of an action (e.g., attempts a function call) that falls within certain criteria (e.g., the function is on a list of sensitive functions).

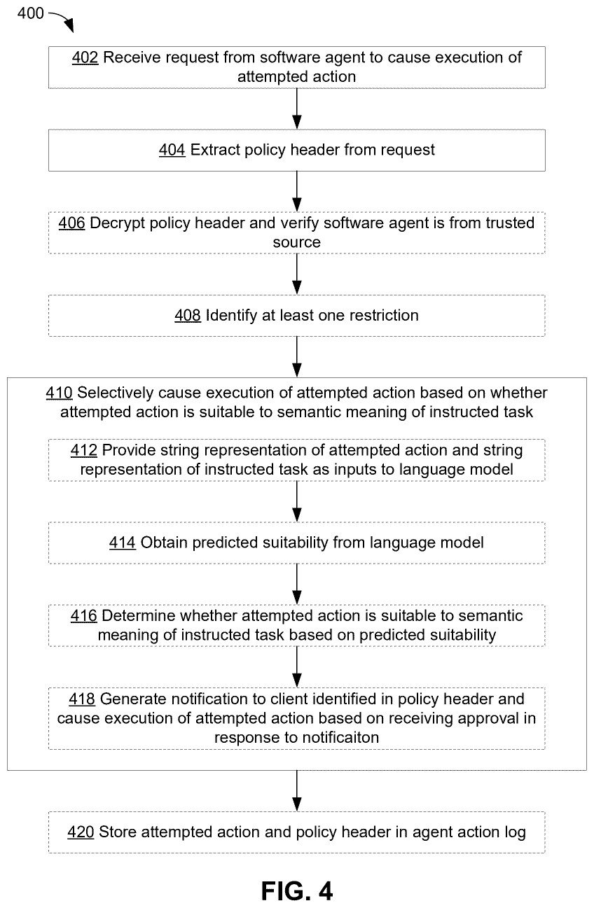

FIG. 4 is a flowchart of an example method 400 for an example embodiment of the present disclosure, which may be performed by a computing system, in accordance with examples of the present disclosure. For example, a processing unit of a computing system (e.g., the processor 202 of the computing system 200 of FIG. 2) may execute instructions (e.g., instructions of the enforcement module 250) to cause the computing system to carry out the example method 400. The method 400 may, for example, be implemented by an online platform or a server. The operations of the enforcement module 250 as described above may illustrate an example implementation of the method 400.

At an operation 402, a request is received from a software agent to cause execution of an attempted action. For example, the software agent may request the attempted action by attempting to call a function of the platform, or by requesting an agent of the platform to perform an action, among other possibilities. The software agent request may include a policy header in addition to the payload that contains data related to the attempted action (e.g., the payload may contain input parameters and syntax for making a function call, the payload may contain the function call itself, or the payload may be a request to an agent of the platform to carry out a task, etc.).

At an operation 404, the policy header is extracted from the request.

Optionally the policy header may be encrypted and, at an optional operation 406, the policy header may be decrypted. The policy header may be encrypted and signed using the private key owned by the source of the software agent, and the policy header may be decrypted to verify that the source of the software agent is a trusted source (e.g., the signature corresponds to a source included in a list of sources trusted by the platform). If the source cannot be verified as a trusted source, execution of the attempted action may be blocked (e.g., an enforcement decision to block the attempted action may be outputted) and the method 400 may end.

Optionally, at an operation 408, at least one restriction may be identified. A restriction may be identified from the policy header itself, from a client profile containing at least one client-defined restriction, and/or from a set of restrictions defined by the platform, as discussed above. In some examples, a restriction may be contained in contextual information (e.g., a conversation summary or conversation history) included in the policy header. Optionally, if a restriction is identified, the restriction may be applied against the attempted action using a rules-based approach. For example, if the restriction specifies that a software agent is not permitted access to financial data stored on the platform, this may be used as a rule to block all attempted actions that requires access to financial data on the platform. If an attempted action is blocked using a rules-based approach at the operation 408, the method 400 may end without further checking whether the attempted action is suitable to the semantic meaning of the instructed task in the following operation 410.

At an operation 410, the computing system selectively causes execution of the attempted action based on whether the attempted action is suitable to the semantic meaning of the instructed task. If the attempted action is suitable to the semantic meaning of the instructed task, execution of the attempted action is permitted. If the attempted action is unsuitable to the semantic meaning of the instructed task, execution of the attempted action is blocked. Performing the operation 410 may include performing one or more of optional operations 412, 414, 416 and/or 418.

At an operation 412, the attempted action and instructed task are provided as inputs to a language model. The attempted action and instructed task may be provided as string representations, for example as part of a prompt to the language model that instructs the language model to determine whether the attempted action is suitable to the semantic meaning of the instructed task. If at least one restriction was identified (e.g., at the operation 408), the at least one restriction may also be provided as input to the language model.

At an operation 414, a predicted suitability is obtained from the language model. The predicted suitability may be in the form of an indication that the attempted action is suitable or unsuitable. The predicted suitability may be in the form of a confidence level (e.g., representing confidence that the attempted action is suitable to the instructed task). In some examples, the predicted suitability may include details on why an attempted action was permitted or blocked (e.g., the predicted suitability that indicates an attempted action should be blocked may identify which of the restriction(s) provided with the input was contravened by the attempted action).

At an operation 416, it is determined whether the attempted action is suitable to the semantic meaning of the instructed task based on the predicted suitability. If the predicted suitability includes an indication of suitability or unsuitability of the attempted action, the operation 416 may use the indication of suitability or unsuitability in the predicted suitability as the determination. If the predicted suitability includes a confidence level of the suitability of the attempted action, the determination may be done by applying a defined threshold to the confidence level (e.g., a suitability confidence level above 80% may be determined to mean that the attempted action is suitable to the semantic meaning of the instructed task, and a suitability confidence level below 80% may be determined to mean that the attempted action is unsuitable to the semantic meaning of the instructed task).

If the attempted action is determined to be unsuitable to the semantic meaning of the instructed task, execution of the attempted action may be blocked (e.g., an enforcement decision to block the attempted action may be outputted) and the method 400 ends. If the attempted action is determined to be suitable to the semantic meaning of the instructed task, the system may cause the attempted action to be executed (e.g., an enforcement decision to permit the attempted action may be outputted).

At an operation 418, prior to causing execution of the attempted action, a notification may be generated. The notification may be provided to a client identified in the policy header (e.g., extracted at the operation 404). The notification may indicate the attempted action by the software agent, and may require the client to provide approval or authorization of the attempted action. The notification may require authentication of the client (e.g., via a one-time password, via a system token, etc.) in order to approve or authorize the attempted action. In some examples, a notification may be generated for the attempted action only for attempted actions that meet a sensitivity criterion (e.g., involving a financial transaction, involving private or sensitive data, involving data belonging to a minor, etc.). In some examples, a client profile may specify whether or not the client should be notified of attempted actions performed by a software agent on the client's behalf. The attempted action may be caused to be executed after receiving an approval or authorization in response to the notification.

Following the operation 410, optionally an operation 420 may be performed. At the operation 420, the attempted action and associated policy header may be stored as a record in an agent action log. In some examples, the record may store the attempted action together with data extracted from the policy header (e.g., the instructed task, any contextual information, an identifier of the client, an identifier of the software agent, an identifier of the source of the software agent, any restriction(s) identified in the policy header, etc.), and may also store an indication of whether the attempted action was permitted or blocked. In some examples, the agent action log may only store attempted actions that were permitted to be executed. The agent action log may be used as an audit trail to track actions performed by software agents on the platform, for example. The records contained in the agent action log may also be used as data samples for training a model to better predict suitability or unsuitability of an attempted action when given a certain instructed task.

Examples of the present disclosure provide a way of checking the suitability of actions attempted by a software agent on a platform. The attempted action can be checked against the semantic meaning of the instructed task contained in a policy header included in the software agent request. Further, restrictions to actions by the software agent can be tailored to the specific agent by carrying information about restriction parameters in the policy header carried by the software agent itself. This provides greater flexibility and specificity, in addition to platform-wide restrictions.

Examples of the present disclosure help to ensure that an action attempted by a software agent is in accordance with the intent (or semantic meaning) of the instructed task (e.g., in accordance with explicit or implicit meaning and/or restrictions in a conversation, which may be provided as contextual information in the policy header). This avoids the problem where a software agent unintentionally attempts an action contrary to the intent of the instructed task. The solution addresses the problem of unintentional error by the software agent, which may not be easily recognized by conventional restrictions that are designed to protect the platform against intentionally malicious actions.

Although the present disclosure includes examples of transformer-based language models, it should be understood that the present disclosure may be applicable to any machine learning-based language model, including language models based on other neural network architectures such as recurrent neural network (RNN)-based language models or state space models (SSMs) (e.g., Hyena). Examples involving the use of an LLM is merely by way of example and the present disclosure is not necessarily so limited. For example, the techniques disclosed herein could potentially also be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM in it, may be employed in association with the above-discussed techniques.

Although the present disclosure has described a language model as an LLM in various examples, it should be understood that the language may be any suitable language model (e.g., including LLMs such as LLaMA, Falcon 40B, GPT-3, or GPT-4, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
receiving a request from a software agent to cause execution of an attempted action;
extracting, from the request, a policy header;
extracting, from the policy header, data representing an instructed task assigned to the software agent; and
selectively causing execution of the attempted action based on whether the attempted action is suitable to a semantic meaning of the instructed task.

2. The method of claim 1, wherein the policy header extracted from the request is encrypted, the method further comprising:
prior to extracting the data representing the instructed task, decrypting the policy header to verify that a source of the software agent is a trusted source.

3. The method of claim 2, wherein the policy header is encrypted and signed by a private key owned by the trusted source.

4. The method of claim 1, further comprising:
determining whether the attempted action is suitable to the semantic meaning of the instructed task by:
providing a string representation of the attempted action and a string representation of the instructed task as inputs to a language model;
obtaining, from the language model, a predicted suitability between the attempted action and the instructed action; and
determining whether the attempted action is suitable to the semantic meaning of the instructed task based on the predicted suitability.

5. The method of claim 4, further comprising:
identifying, from the policy header, at least one restriction to be applied to the instructed task or the attempted action, wherein the at least one restriction is included as an input to the language model.

6. The method of claim 1, further comprising:
extracting, from the policy header, an identifier of a client associated with the software agent or associated with the instructed task; and
identifying, from a client profile of the client, at least one client-defined restriction that limits actions by the software agent;
wherein selectively causing execution of the attempted action is further based on whether the attempted action is permissible within the at least one client-defined restriction.

7. The method of claim 1, wherein selectively causing execution of the attempted action comprises:
after determining that the attempted action is suitable to the semantic meaning of the instructed task and before causing execution of the attempted action, generating a notification to notify a client, identified in the policy header, about the attempted action.

8. The method of claim 7, wherein the notification includes a request to approve the attempted action, wherein the method further comprises:
receiving an approval in response to the notification;
wherein selectively causing execution of the attempted action is further based on receiving the approval.

9. The method of claim 1, further comprising:
receiving a further request from the software agent to cause execution of a further attempted action; and
selectively blocking execution of the attempted action based on the attempted action being unsuitable to the semantic meaning of the instructed task.

10. The method of claim 1, further comprising:
storing, in an agent action log, a record of the executed attempted action together with the policy header.

11. A computer system comprising:
at least one processor; and
a computer readable medium storing instructions that, when executed by the at least one processor, cause the computer system to:
receive a request from a software agent to cause execution of an attempted action;
extract, from the request, a policy header;
extract, from the policy header, data representing an instructed task assigned to the software agent; and
one of:
cause execution of the attempted action when the attempted action is suitable to a semantic meaning of the instructed task; or
block execution of the attempted action when the attempted action is unsuitable to the semantic meaning of the instructed task.

12. The computer system of claim 11, wherein the policy header extracted from the request is encrypted, the instructions further causing the computer system to:
prior to extracting the data representing the instructed task, decrypt the policy header to verify that a source of the software agent is a trusted source.

13. The computer system of claim 12, wherein the policy header is encrypted and signed by a private key owned by the trusted source.

14. The computer system of claim 11, wherein the instructions further cause the computer system to:
determine whether the attempted action is suitable or unsuitable to the semantic meaning of the instructed task by:
providing a string representation of the attempted action and a string representation of the instructed task as inputs to a language model;
obtaining, from the language model, a predicted suitability between the attempted action and the instructed action; and
determining that the attempted action is suitable or unsuitable to the semantic meaning of the instructed task based on the predicted suitability.

15. The computer system of claim 14, wherein the instructions further cause the computer system to:
identify, from the policy header, at least one restriction to be applied to the instructed task or the attempted action, wherein the at least one restriction is included as an input to the language model.

16. The computer system of claim 11, wherein the instructions further cause the computer system to:
extract, from the policy header, an identifier of a client associated with the software agent or associated with the instructed task; and
identify, from a client profile of the client, at least one client-defined restriction that limits actions by the software agent;
wherein execution of the attempted action is caused when the attempted action is suitable to a semantic meaning of the instructed task and when the attempted action is permissible within the at least one client-defined restriction.

17. The computer system of claim 11, wherein the instructions further cause the computer system to cause execution of the attempted action by:
when the attempted action is suitable to the semantic meaning of the instructed task and before causing execution of the attempted action, generating a notification to notify a client, identified in the policy header, about the attempted action.

18. The computer system of claim 17, wherein the notification includes a request to approve the attempted action, wherein the instructions further cause the computer system to:
receive an approval in response to the notification;
wherein execution of the attempted action is caused after receiving the approval.

19. The computer system of claim 11, wherein the instructions further cause the computer system to:
store, in an agent action log, a record of the executed attempted action together with the policy header.

20. A non-transitory computer-readable medium storing instructions that, when executed by at least one processor of a computer system, cause the computer system to:
receive a request from a software agent to cause execution of an attempted action;
extract, from the request, a policy header;
extract, from the policy header, data representing an instructed task assigned to the software agent; and
one of:
cause execution of the attempted action when the attempted action is suitable to a semantic meaning of the instructed task; or
block execution of the attempted action when the attempted action is unsuitable to the semantic meaning of the instructed task.
